(19) United States
(12) Patent Application Publication
(10) Pub. No.: US 2026/0240176 A1
(43) Pub. Date: Aug. 20, 2026

(54) PROCESSING LINE AND METHOD FOR PROCESSING PRODUCTS OF THE FOOD PROCESSING INDUSTRY AND IN PARTICULAR STUNNED POULTRY BODIES

(71) Applicant: BAADER Poultry Holding GmbH, Lübeck (DE)

(72) Inventor: Ryan Wesley O'Dell, Weatherby Lake, MO (US)

(73) Assignee: BAADER Poultry Holding GmbH, Lübeck (DE)

(21) Appl. No.: 19/161,957

(22) PCT Filed: Mar. 1, 2024
(86) PCT No.: PCT/EP2024/055389

§ 371 Date: Sep. 3, 2025

Related U.S. Application Data
(60) Provisional application No. 63/488,379, filed on Mar. 3, 2023.

(51) Int. Cl. A22B 3/08; A22B 7/00

(52) U.S. Cl. CPC A22B 3/086; A22B 7/007

(57) ABSTRACT

The disclosure relates to a processing line for processing food products, the processing line including a transport device for the transport products along a transport path in a transport direction, at least two processing stations arranged along the transport path, the at least two processing stations arranged one behind the other in the transport direction, and a control device for automated control of the processing line. The transport device and processing stations are connected to the control device. A first processing station arranged upstream in the transport direction is assigned a detection means for detecting a processing result from the first processing station and for transmitting the information to the control device. The processing line includes means for identifying products. The control device processes the information obtained from the detection means and marks those products defined as being unsatisfactorily processed by activating the means for identifying along the transport path.

### CROSS-REFERENCE TO RELATED APPLICATIONS

This application is a U.S. National Stage filing of International Application No. PCT/EP2024/055389, filed Mar. 1, 2024, which claims priority to U.S. Provisional Application No. U.S. 63/488,379, filed Mar. 3, 2023, both of which are hereby incorporated by reference in their entirety including the drawings.

### TECHNICAL FIELD

The present specification generally relates to a processing line, configured and adapted for processing products of the food processing industry, in particular stunned poultry.

### BACKGROUND

Processing lines and methods are used in the food processing industry for the processing of products, in particular stunned poultry transported in a suspended manner. Usually, two or more than two processing steps take place at processing stations arranged one behind the other in the transport direction. In many cases, the processing quality of a first method step is a prerequisite for the processing in the subsequent method step. In other words, subsequent method steps require the previous method steps to be performed correctly. The processing lines and methods known to date are heavily dependent on the experience of the operator working on the processing line. If the operator recognizes unsatisfactory processing, the operator can intervene. Nevertheless, reliable recognition of unsatisfactory processing in high-throughput processing lines is hard to achieve, and unsatisfactory processing is sometimes not always recognizable even to experienced operators; therefore, products processed unsatisfactorily at a first processing station are still processed at a subsequent processing station: this leads to poorer quality end products.

There is therefore a need to recognize potential processing errors in real time and to be able to correctly complete the processing or the corresponding method step—whether automatically or manually—in order to be able to perform the next processing step. Taking the example of poultry processing, stunned animals are transported along the processing line suspended by shackles. At least two processing stations are arranged along the transport route. The first processing station is for example an apparatus for killing the stunned, but still living, poultry. The or each subsequent processing station then serves for the further processing of the killed poultry. In order for the further processing to be carried out exclusively on definitively killed animals, it is necessary to monitor the initial step, namely the killing of the animals. In other words, there is a need for real-time error recognition and remediation along an active poultry slaughter line.

### SUMMARY

The present disclosure relates to a processing line, configured and adapted for processing products of the food processing industry, in particular stunned poultry, comprising a transport device, configured and adapted for the suspended transport of separated products along a transport path in the transport direction T, at least two processing stations which are arranged along the transport path, wherein the at least two processing stations are arranged one behind the other in the transport direction T, and a control device for the automated control of the processing line, wherein the transport device and each processing station are connected to the control device.

The present disclosure also relates to a method for processing products of the food processing industry, in particular stunned poultry, comprising the steps of: suspended transport of separated products along a transport route in the transport direction T by means of a transport device; processing of the products at a first processing station arranged along the transport route; processing of the products processed at the first processing station at least at a second processing station arranged after the first processing station in the transport direction T, wherein the transport device and the processing stations are controlled by means of a control device for an automated method.

One object of the present disclosure is therefore that of proposing a processing line in which the further processing of the products, processed in a first processing station, at a subsequent processing station reliably takes place exclusively on correctly processed products. Specifically, the object consists of proposing a processing line in which only poultry which has been stunned and definitively killed at a first processing station moves onto the subsequent processing station. Another object of the present disclosure is to propose a corresponding method.

In embodiments, the object is solved by a processing line as mentioned at the outset, in that at least the first processing station arranged upstream in the transport direction T is assigned a detection means which is configured and adapted for detecting the processing result from the first processing station and for transmitting the information to the control device, wherein the processing line additionally comprises means for identifying products, and the control device is configured and adapted to process the information obtained from the detection means and to mark those products defined as being unsatisfactorily processed by activating the means for identifying along the transport path. As a result, a product which must not move onto the processing station downstream of the first processing station without further re-processing is made clear to every operator, regardless of their experience. The operator can remove the unsatisfactory product from the processing line. Optionally, after removal, an operator can also re-process the unsatisfactorily processed product and return it to the processing line. The solution according to the present disclosure ensures product tracking through the processing line. Visualising unsatisfactorily processed products makes it possible to definitively prevent erroneous processing of unsatisfactorily processed products at subsequent processing stations.

In embodiments, the processing line is a slaughter line for stunned poultry, wherein the first processing station is an apparatus for killing stunned poultry. The processing line according to the present disclosure ensures that only reliably killed poultry are further processed. It is particularly desirable and beneficial to animal welfare if only reliably killed poultry are supplied to a subsequent scalding process for defeathering the poultry.

In embodiments, more than two processing stations are arranged one behind the other in the transport direction T, wherein the or each processing station is assigned a detection means for detecting the processing result, the detection means being connected to the control device. This embodiment ensures that each processing station in the processing line is monitored, and therefore unsatisfactorily processed products can be monitored and identified along the entire processing line. A processing line may for example be formed of an apparatus for killing the stunned poultry as the first processing station, and an apparatus for scalding the killed poultry as the second processing station. Another processing line may for example be formed of an oil gland cutter as the first processing station, a vent cutter as the second processing station, and an opener as the third processing station. However, the processing line may be formed of more than three processing stations, with all apparatuses which are configured and adapted for processing products of the food processing industry, and in particular for processing stunned poultry, being considered as processing station.

In embodiments, the transport device comprises a circularly driven transport chain, on which shackles are arranged for receiving, holding and for the suspended transport of one poultry body each. This embodiment ensures, on the one hand, secure transport of the poultry bodies (synonym for poultry) from processing station to processing station. On the other hand, said transport device can ensure simple and reliable product tracking along the transport route.

In embodiments, each processing station arranged downstream in the transport direction T is configured and adapted only to process those products that have been processed correctly in the adjacent upstream processing station. Detecting the poultry and identifying the unsatisfactorily processed poultry makes it possible to ensure, by means of the control device, that the unsatisfactorily processed poultry are either withdrawn or that the subsequent processing station is stopped for the processing step.

In embodiments, the or each detection means comprises at least one camera for recording the processing result of the respective processing station, wherein the camera is configured and adapted to transmit this information to the control device. Individual photos, series of photos or video sequences can be recorded using the camera and processed by the control device. The images can for example be automatically compared with reference images. If there is a defined deviation from the reference image, the means for identifying unsatisfactorily processed products can be activated. Instead of one camera, it is also possible to use multiple cameras directed onto the processed product from different angles, and/or other optical and/or sensor-based recording and/or measuring means. It is desirable that, from each processing unit of each processing station—it being possible for each processing station to have one processing unit or more than two and in particular more than ten and particularly between fifteen and twenty or more than twenty processing units—images can be recorded and/or detection can be carried out which enables conclusions to be drawn regarding unsatisfactory, i.e. incorrect, processing.

In embodiments, the or each detection means comprises at least one detection element for determining the power consumption of an electric motor assigned to one or each processing station, wherein the detection element is configured and adapted to transmit this information to the control device. The power consumption can be used to draw conclusions regarding the load situation of the electric motor. If the electric motor is running with no load, low power consumption can be measured. If there is a load acting on the electric motor, for example if a tool driven by the electric motor is penetrating into the product, larger or higher power consumption can be measured. The fluctuations in power consumption can be used to draw conclusions as to whether a tool was engaging with the product for satisfactory processing or whether only unsatisfactory processing was performed on account of too low a fluctuation from the reference value. If there is a defined deviation from the reference value, the means for identifying unsatisfactorily processed products can be activated.

In embodiments, the or each processing station comprises a processing tool driven by means of an electric motor. This makes it possible to directly and reliably detect in real time whether the processing tool has worked properly, in order, in the event of unsatisfactory processing, to visibly mark the corresponding product continuously along the whole transport route.

In embodiments, the apparatus for killing the stunned poultry bodies comprises a circular knife to which an electric motor is assigned in order to drive said knife in rotation. The penetration of the circular blade into the poultry body, and the severing of the main artery, leads to a certain power consumption by the electric motor. The value of this power consumption is for example known, having been empirically determined, and serves as a reference value. If the detected value deviates from this reference value within a defined range, this makes it possible to conclude that correct processing has not taken place, and that the poultry has thus not been definitively and correctly killed. As a result, the unsatisfactorily processed product can be identified in real time, such that the operator readily recognises this product and can remove it in a targeted manner from the processing line in order to prevent further processing in a subsequent processing station or in order to reliably kill the poultry before it is further processed and/or reintroduced into the processing line.

In embodiments, the or each electric motor is linked via an interface, in particular an IO-Link protocol, to a start-up control, in particular to a hybrid motor starter, and is connected to the control device. This makes it particularly simple to detect the power consumption and to further process the information obtained. To this end, the data obtained is transmitted to a programmable logic controller (PLC) as the control device.

In embodiments, the control device comprises a programmable logic controller linked to an operating element. The operating element is a human-machine interface, for example a keyboard, touch screen or the like.

In embodiments, the means for identifying products comprises illumination means which are connected to the control device and are configured and adapted to mark the products transported along the transport path which have been unsatisfactorily processed. Lasers, diodes, LEDs or the like can be used as illumination means in order to produce light spots, light bands or light sequences. The or each illumination means can be arranged under the transport device, for example under the shackles. However, other configurations and arrangements are also possible. In particular, at least one illumination means can be assigned to each shackle. The or each illumination means can be configured and adapted to illuminate the unsatisfactorily processed products. In other embodiments, the or each illumination means is configured and adapted to identify the respective position along the transport route of the products which have been unsatisfactorily processed.

In embodiments, as a means for identifying products, a light band is arranged along the transport path parallel to the transport device, which light band, by means of the control device, marks each unsatisfactorily processed poultry body with at least one light spot, wherein the or each light spot is configured and adapted such that it moves along with the unsatisfactorily processed product in the transport direction T. In another embodiment, each shackle is assigned an illumination means as a means for identifying products, such that the illumination means is configured and adapted to be movable along with the shackle. Other options for visually identifying unsatisfactorily processed products can also be used.

In embodiments, the means for identifying products comprises illumination means which are configured and adapted to assign different light colours to different processing stations. Taking the example of a processing line with an oil gland cutter as one processing station, a vent cutter as the downstream processing station and an opener as the downstream processing station, it being possible for each of these stations to have a processing unit or a plurality of processing units, this means for example that products which have been unsatisfactorily processed at the oil gland cutter are marked with a blue light, products which have been unsatisfactorily processed at the vent cutter are marked with a red light, and products which have been unsatisfactorily processed at the opener are marked with a purple light. This enables the operator to clearly assign the processing station responsible for the unsatisfactory processing. On the one hand, this information can be used by the control device in order to potentially send an alarm to the maintenance team, for example, in order to carry out targeted maintenance on a selected processing station. On the other hand, the operator is shown in a targeted manner which product has been unsatisfactorily processed, and at which processing station.

In embodiments, the object is achieved by a method having the steps mentioned at the outset, in that the first processing step at the first processing station is detected by means of a detection means with respect to the processing result, and the information is transmitted to the control device such that the or each subsequent processing step is only performed if the first processing step has been performed correctly, and in that products which have been unsatisfactorily processed are marked, by means of the control device, by a means for identifying products along the transport path. Firstly, detection makes it possible to decide whether a product has been correctly or unsatisfactorily processed. With this knowledge, the unsatisfactorily or inappropriately processed products are then marked by being assigned an illumination which directly or indirectly identifies the product. The products then move along the transport route with this identification. Every operator is then able to remove the products identified in this way and to thereby ensure that only correctly processed products reach the subsequent processing station.

In embodiments, the method is used for processing stunned poultry, wherein stunned poultry are killed in a first processing step at the first processing station and the killed poultry are further processed at at least one second processing station. The killing of the poultry is the central method step, because it is only permitted to further process definitively killed poultry for reasons of animal welfare and animal safety. If the killing of the poultry is monitored, it is possible to ensure that further processing is only available for the correctly killed poultry. All poultry processed unsatisfactorily in the first method step, i.e. poultry that have not been reliably killed, are identified by the visual identification in the form of a light which moves along with the product, and are then separated out and optionally re-processed.

In embodiments, the or each processing step is monitored by means of at least one camera, and the information is transmitted to the control device. At each processing unit of a processing station, the processed product is recorded by the or each camera in order to determine, by means of the control device, whether the processed product meets the requirements of a correctly processed product, for example by comparison with a reference image. This enables quick and reliable detection that ensures identification of unsatisfactorily processed products in real time.

In embodiments, the or each processing step is monitored by means of at least one detection element for determining the power consumption of an electric motor assigned to one or each processing station, and the information is transmitted to the control device. Fluctuations in the power consumption are an indication of too low or too high loading of the electric motor, for example if the tool driven by the electric motor has not penetrated into the product at all (low resistance with low power consumption) or meets with resistance within the product (high resistance with high power consumption). For example, comparing the determined power consumption with a reference value makes it possible to determine whether the product in question is a correctly processed product or an unsatisfactorily processed product. This enables quick and reliable detection that ensures identification of unsatisfactorily processed products in real time. Taking the example of killing a stunned poultry, the circular knife driven by the electric motor leads to a defined power consumption. The defined power consumption is only reached if the circular blade penetrates into the poultry at the correct position and meets the main artery. It is only in this case that correct killing can be assumed. If the detected power consumption deviates from the reference value, it can be reliably assumed that the processing step has only been unsatisfactorily carried out.

In embodiments, products which have been identified by the control device, using the information transmitted to the control device by the detection means, as being unsatisfactorily processed, are marked by means of an illumination means activated by the control device such that, upon transport along the transport path from the first processing station to the processing station arranged downstream thereof, the products marked as unsatisfactory are identifiable as being unsatisfactory. The illumination means illuminates the identified products themselves or marks the position at which the identified product is currently located along the transport route. For the operator, this facilitates recognition and removal of all unsatisfactorily processed products, even at a high processing rate on the processing line.

In embodiments, light spots light up underneath the products identified as being unsatisfactorily processed, such that these products are re-processed or removed before reaching the next processing station in the transport direction T. The light band makes it possible for each product identified as unsatisfactorily processed to be tracked through the entire processing line and signalled at any desired position. The light spots can also light up above, behind, in front or to the side of the poultry in question.

In embodiments, light spots light up on shackles from which the products are transported in a suspended manner along the transport route if these products have been identified as being unsatisfactorily processed, such that these products are re-processed or removed before reaching the next processing station in the transport direction T. This enables the products to be directly and immediately assigned to the respective shackles and the corresponding position along the transport route.

In embodiments, a plurality of processing stations arranged one behind the other in the transport direction T are detected with respect to their processing result, wherein each of the products identified as being unsatisfactorily processed is assigned at least one coloured light spot which can be assigned to a specific processing station in relation to the colour. This makes it possible to simply and quickly assign the processing station, and more precisely also the processing unit of the processing station, at which an error has occurred. As a result, a repair, maintenance or any other intervention for remedying a potential problem can be initiated in a targeted manner.

Optionally, an alarm is triggered in the event that a predetermined number of unsatisfactorily processed products is generated at one processing station of the processing line. This ensures a rapid response for remedying the potential source of the error.

In embodiments, the method is performed with a processing line according to the claims.

Further embodiments resulting from the abovementioned method steps have already been described in conjunction with the processing line, and therefore reference is made to the corresponding passages in order to avoid repetitions.

Further embodiments of the processing line, and also of the method, result from the dependent claims and the description.

### BRIEF DESCRIPTION OF THE DRAWINGS

Embodiments of the subject matter of the disclosure are explained in more detail using the appended drawings. The drawing shows:

FIG. 1 a schematic representation of a section of a first embodiment of a poultry slaughter line,

FIG. 2 a schematic representation of a section of a further embodiment of a poultry slaughter line,

FIG. 3 a graph of the detection result for each processing unit of a first processing station of the poultry slaughter line according to FIG. 2,

FIG. 4 a graph of the detection result for each processing unit of a second processing station of the poultry slaughter line according to FIG. 2, and

FIG. 5 a graph of the detection result for each processing unit of a third processing station of the poultry slaughter line according to FIG. 2.

### DETAILED DESCRIPTION

The processing line shown in the drawings serves for processing stunned poultry bodies. In other embodiments, other products can also be detected and identified. As monitored parameters, aside from checking the correct killing of poultry or checking the correct performance of an oil gland cut or performance of vent cuts or opening steps, it is also possible to detect other criteria which are important for the processing of poultry bodies.

The embodiments shown in the drawing shows a processing line 10, configured and adapted for processing products of the food processing industry, in particular stunned poultry 11. The processing line 10 comprises a transport device 12, configured and adapted for the suspended transport of separated products along a transport path in the transport direction T, at least two processing stations 13, 14, 15 which are arranged along the transport path, wherein the at least two processing stations 13, 14, 15 are arranged one behind the other in the transport direction T, and a control device 16 for the automated control of the processing line 10, wherein the transport device 12 and each processing station 13, 14, 15 are connected to the control device 16.

According to the present disclosure, this processing line 10 is characterised in that at least the first processing station 13 arranged upstream in the transport direction T is assigned a detection means 17 which is configured and adapted for detecting the processing result from the first processing station 13 and for transmitting the information to the control device 16, wherein the processing line 10 additionally comprises means 18 for identifying products, and the control device 16 is configured and adapted to process the information obtained from the detection means 17 and to mark those products defined as being unsatisfactorily processed by activating the means 18 for identifying along the transport path.

The features and further developments described below are embodiments, whether taken alone or in combination. Reference is explicitly made to the fact that features which are described in conjunction with one another or which are described in a shared embodiment in the claims and/or the description and/or the figures can also develop the processing line 10 described above in a functionally independent manner.

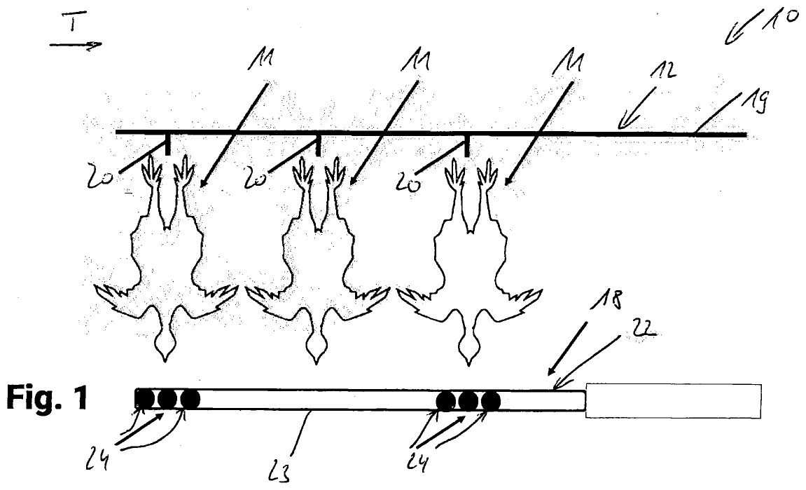

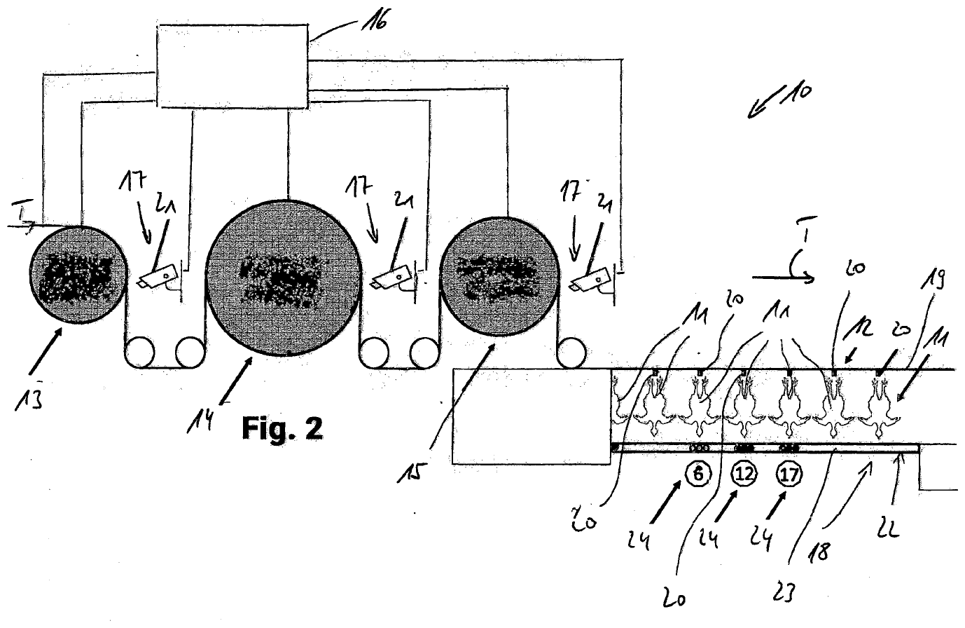

The processing lines 10 shown are slaughter lines for stunned poultry 11. FIG. 1 shows a processing line 10 having two processing stations 13, 14. The first processing station 13, not explicitly shown, is an apparatus for killing stunned poultry 11. The second processing station 14, not explicitly shown, is an apparatus for scalding killed poultry 11. The apparatus for killing poultry 11 comprises a circular knife driven by means of an electric motor. To this end, the electric motor is also connected to the control device 16. FIG. 2 shows a processing line 10 having more than two processing stations 13, 14, 15 in cutout details, namely having an apparatus for oil gland cutting as the first processing station 13, having a vent cutter as the second processing station 14, and having an opener as the third processing station 15. Each of the processing stations 13, 14, 15 can comprise a processing unit. In the described embodiment, the first processing station 13 has sixteen processing units, the second processing station 14 has twenty processing units, and the third processing station 15 has sixteen processing units. Each processing station 13, 14, 15 is assigned its own detection means for detecting the processing result, each detection means being connected to the control device 16.

In embodiments, the transport device 12 comprises a circularly driven endless transport chain 19, on which shackles 20 are arranged for receiving, holding and for the suspended transport of one poultry body 11 each. Each shackle can be assigned a sensor device, not explicitly shown. The poultry bodies 11 can be transported from processing station 13 to processing station 14 to processing station 15, etc., by means of the transport chain 19 with the shackles 20 arranged thereon. Each processing station 13, 14, 15 arranged downstream in the transport direction T is configured and adapted only to process those products that have been processed correctly in the adjacent upstream processing station 13, 14, 15.

FIG. 2 shows a processing line 10 in which the or each detection means 17 comprises at least one camera 21 for recording the processing result of the respective processing station 13, 14, 15, wherein the camera 21 is configured and adapted to transmit this information to the control device. The or each camera 21 monitors and records the performance of each of the sixteen or twenty processing units of the processing stations 13, 14, 15. FIG. 1 shows a processing line 10 in which the or each detection means 17 comprises at least one (not explicitly shown) detection element for determining the power consumption of an electric motor assigned to one or each processing station 13, 14, wherein the detection element is configured and adapted to transmit this information to the control device.

In embodiments of the processing line 10 according to FIG. 1, the first processing station 13 has a circular knife driven by means of an electric motor. In the processing line according to FIG. 2, all processing stations 13, 14, 15 comprise a processing tool driven by means of an electric motor. The or each electric motor is linked via an interface, in particular an IO-Link protocol, to a start-up control, in particular to a hybrid motor starter, and is connected to the control device 16. The control device 16 comprises a programmable logic controller linked to an operating element. Each means 18 for identifying can be activated by this control device 16.

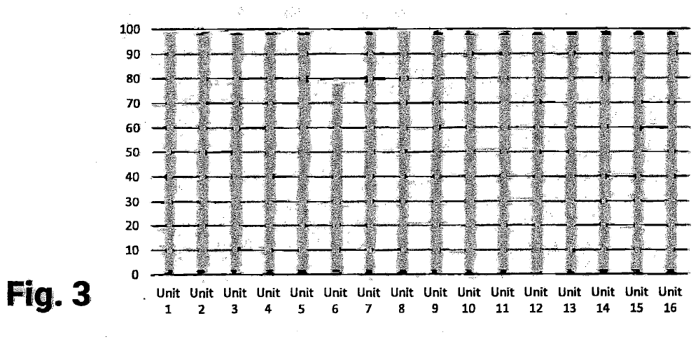

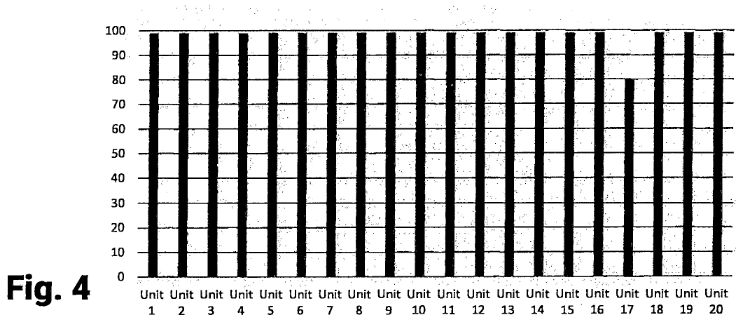

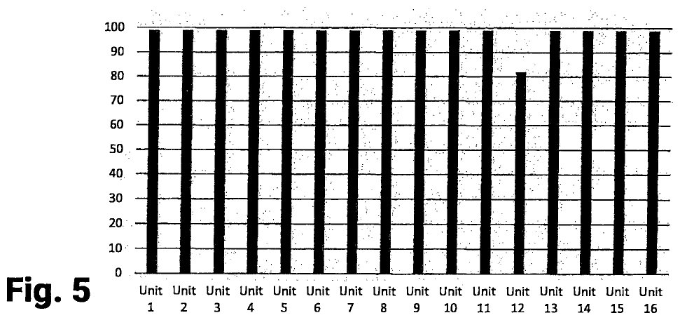

The means 18 for identifying products comprises illumination means 22 which are connected to the control device 16 and are configured and adapted to mark the products transported along the transport path which have been unsatisfactorily processed. In the embodiment according to FIG. 1, as a means 18 for identifying products, a light band 23 is arranged along the transport path parallel to the transport device 12, which light band, by means of the control device 16, marks each unsatisfactorily processed poultry body 11 with at least one light spot 24, wherein the or each light spot 24 is configured and adapted such that it moves along with the unsatisfactorily processed product in the transport direction T. The means 18 for identifying is also configured accordingly in the embodiment according to FIG. 2. In this embodiment, the illumination means 22 are configured and adapted to assign different light colours to different processing stations 13, 14, 15. For example, the first processing station 13 upstream in the transport direction T is assigned blue light spots 24 in the event of unsatisfactorily processed products. It can be seen in FIG. 3 that a measurement value that deviates from the reference value has clearly been detected at processing unit six of the first processing station 13. Accordingly, the product processed at this station is marked with a blue light spot 24 or a plurality of blue light spots 24 along the transport route. For example, the second processing station 14, downstream of the first processing station 13 in the transport direction T, is assigned red light spots 24 in the event of unsatisfactorily processed products. It can be seen in FIG. 4 that a measurement value that deviates from the reference value has clearly been detected at processing unit seventeen of the second processing station 14. Accordingly, the product processed at this station is marked with a red light spot 24 or a plurality of red light spots 24 along the transport route. For example, the third processing station 15, downstream of the second processing station 14 in the transport direction T, is assigned purple light spots 24 in the event of unsatisfactorily processed products. It can be seen in FIG. 5 that a measurement value that deviates from the reference value has clearly been detected at processing unit twelve of the third processing station 15. Accordingly, the product processed at this station is marked with a purple light spot 24 or a plurality of purple light spots 24 along the transport route. In a variant that is not explicitly shown, each shackle is assigned an illumination means 22 as a means 18 for identifying products, such that the illumination means 22 is configured and adapted to be movable along with the shackle 20.

Hereinafter, a processing line 10 is shown and described, in other words as a system for processing poultry 11 for identifying incomplete killing and for tracking system performance. The system tracks each shackle 20 and the associated poultry 11 connected to the shackle 20, and measures small current fluctuations in the electric motors that rotate the blades that cut through the throat of the poultry 11 during a first step in the poultry processing, identifies any poultry 11 that was not killed in the first step, and as a result makes it possible to correctly kill the failed, i.e. unsatisfactorily processed, poultry 11 before the poultry 11 passes onto the next step in the processing process. Moreover, the system tracks the shackles 20 and the poultry 11 that pass through the processing process, in order to identify failed processes in the processing station 13, 14, 15 which need to be taken into account by the operator of the processing line 10.

Hereinafter, the method for processing products of the food processing industry, in particular stunned poultry 11, is described in more detail. The poultry 11 are transported separately along a transport route in the transport direction T by means of a transport device 12. In the process, they pass through at least two processing stations 13, 14, 15. The poultry 11 are processed at a first processing station 13 arranged along the transport route; in FIG. 1 this is an apparatus for killing stunned poultry 11, and in FIG. 2 it is an oil gland cutter. Subsequently, the poultry 11 processed at the first processing station 13 are processed at least at a second processing station 14 arranged after the first processing station 13 in the transport direction T; in FIG. 1 this is an apparatus for scalding killed poultry 11, and in FIG. 2 it is a vent cutter. The poultry 11 processed in this way can subsequently be further processed, for example at a third processing station 15; in FIG. 2, this is an opener. In the process, the transport device 12 and the processing stations 13, 14, 15 are controlled by means of a control device 16 for an automated method.

According to the present disclosure, this method is characterised in that the first processing step at the first processing station 13 is detected by means of a detection means 17 with respect to the processing result, and the information is transmitted to the control device 16 such that the or each subsequent processing step is only performed if the first processing step has been performed correctly, and in that products which have been unsatisfactorily processed are marked, by means of the control device 16, by a means for identifying products along the transport path. The processed product and/or a tool performing the processing are therefore monitored with respect to specific parameters and/or with respect to the appearance of the poultry and/or other parameters that allow conclusions to be drawn about the processing, and are identified in the event that they are identified as being incorrectly processed.

As described, the method shown according to FIG. 1 is used for processing stunned poultry 11, wherein stunned poultry 11 are killed in a first processing step at the first processing station 13 and the killed poultry 11 are further processed at at least one second processing station 14, 15. In the method with a processing line 10 according to FIG. 1, the or each processing step is monitored by means of at least one detection element for determining the power consumption of an electric motor assigned to one or each processing station 13, 14, the information being transmitted to the control device 16. In the method with a processing line 10 according to FIG. 2, the processing stations 13, 14, 15 and the respective processing results at the processing stations 13, 14, 15 are monitored by means of at least one camera 21, this information also being transmitted to the control device 16.

Products which have been identified by the control device 16, using the information transmitted by the detection means 17, as being unsatisfactorily processed, are marked by means of an illumination means 22 activated by the control device 16 such that, upon transport along the transport path from the first processing station 13, 14, 15 to the processing station 13, 14, 15 arranged downstream thereof, the products marked as unsatisfactory are identifiable as being unsatisfactory. The control device 16 processes the incoming information, data, images and the like by comparing them for example with previously defined and stored reference values. One criterion for triggering the illumination means 22 may for example be if the detected measurement value, i.e. an image, a measured power consumption or the like, is outside a tolerance range which was also previously defined and stored. This leads to the illumination means 22 being activated for the product in question. By means of this activation, light spots 24 light up underneath the products identified as being unsatisfactorily processed, such that these products are re-processed or removed before reaching the next processing station 13, 14, 15 in the transport direction T. Optionally, the light spots 24 can also light up on shackles 20 from which the products are transported in a suspended manner along the transport route if these products have been identified as being unsatisfactorily processed, such that these products are re-processed or removed before reaching the next processing station 13, 14, 15 in the transport direction T. After re-processing, the products can be re-introduced into the processing line 10.

In the method with the processing line 10 according to FIG. 2, a plurality of processing stations 13, 14, 15 arranged one behind the other in the transport direction T are detected with respect to their processing result, wherein each of the products identified as being unsatisfactorily processed is assigned at least one coloured light spot 24 which can be assigned to a specific processing station 13, 14, 15 in relation to the colour. An alarm is triggered in the event that a predetermined number of unsatisfactorily processed products is generated at one processing station 13, 14, 15 of the processing line 10. Optionally, the method is performed with a processing line 10 according to one or more of claims 1 to 15.

In other words, in embodiments, the concept according to the present disclosure—as already described above—provides for determining the power consumption of the individual electric motors at the processing stations 13, 14, 15, for example by means of a hybrid motor starter. The data collected in the process is sent to a control device (PLC) 16. The control device 16 uses a sensor in the shackle 20 in order to assign the determined power consumption to the poultry body 11 suspended from the shackle 20. In the event that this poultry body 11 has been unsatisfactorily processed, for example because the killing has not worked properly—through the lower power consumption—the poultry body 11 and/or the shackle 20 is illuminated, the illumination following the poultry body 11 along the transport route. Thus, the operator can immediately recognise which poultry body 11 has only been unsatisfactorily processed.

Specifically, in embodiments, the poultry, namely the poultry birds 11, is suspended in a processing line 10 from a suspended conveyor as transport device 12 having a bracket or carrier as shackle 20 as it enters a killing apparatus as processing station 13 for the killing step of the processing process. The killing apparatus comprises a circular blade which rotates by actuation from an electric motor. The motor is linked to a hybrid motor starter via an IO-Link protocol. The motor is also controlled by a programmable logic controller (PLC) linked to a human-machine interface. The system monitors the current intensity of the motor via the hybrid motor starter. The PLC monitors the data from the hybrid motor starter and also receives data that assigns the shackle 20 holding the poultry to the killing apparatus. If a bracket passes the killing apparatus and the system does not register a sufficient change in current intensity which indicates the resistance of the electric motor rotating the circular blade, the system recognises a failed kill. A light signalling system as means 18 for identifying, which light signalling system is located under the poultry, causes a series of lights to light up next to the unkilled poultry.

FIG. 1 shows a light signalling system in the vicinity of the poultry leaving the killing apparatus, wherein a series of signalling lamps depicted as red lights light up in the vicinity of the unkilled poultry. Other arrangements of the signalling lights comprise lights arranged above, below, behind, in front of or next to the poultry. In embodiments, the poultry is illuminated by a light. In this example, the signalling lamps next to the poultry signal unkilled animals and, while the poultry passes from left to right along the conveyor belt, the signalling lamps follow along next to the poultry and signal the unkilled animal. The personnel in charge of the processing line can recognise which poultry requires attention by means of the lights.

FIG. 2 shows and describes an implementation of additional processing steps and performance monitoring and tracking, in which a light signalling system next to a conveying system provides information regarding incomplete operations by a processing unit of processing stations 13, 14, 15. A processing station 13, 14, 15 can have one or more processing units. In one aspect of the performance monitoring and tracking system and method, in one situation during the poultry processing, in which the bird first encounters an oil gland cutter processing machine, then a vent cutter processing machine, and finally an opener processing machine, cameras 21 linked to an imaging system of the PLC monitor the performance of each processing unit of each processing station 13, 14, 15. The PLC receives data that links each bracket to each poultry part in the processing process. If a camera 21 registers an erroneous or incomplete operation by a processing unit of a processing station 13, 14, 15, the system allocates a series of coloured lights which move along the processing line 10 next to the poultry. If for example one of the processing units of the oil gland processing machine performs an incomplete operation on a poultry body, for example faulty cuts, or does not perform the operation, for example unit six of the sixteen units (see FIG. 3), the system assigns a series of first coloured lights to the shackle 20 transporting the poultry along the processing line 10, in order to signal to an operator that maintenance is required on the processing system in order to remedy the problem. If one of the processing units of the poultry processing machine performs an incomplete operation, for example faulty cuts, or does not perform the operation, for example unit seventeen of the twenty units (see FIG. 4), the system assigns a series of second coloured lights to the shackle 20 transporting the poultry. If one of the processing units of the opener processing machine performs an incomplete operation, for example faulty cuts, or does not perform the operation, for example unit twelve of the sixteen units (see FIG. 5), the system assigns a series of third coloured lights to the shackle 20 transporting the poultry.

The method has been described taking the example of detecting and identifying unkilled poultry bodies and unsatisfactorily processed poultry bodies in an oil gland cutter, a vent cutter and an opener. However, the detection and corresponding identification according to the present disclosure can also accordingly be applied to other uses, for example for detecting and identifying killed poultry 11 after suspension on the shackles, when re-suspending poultry 11 removed from the processing line, for detecting and identifying injured poultry 11, for detecting and identifying poultry 11 which still have their head, for detecting and identifying poultry 11 which still have their neck, for detecting and identifying mutilated poultry 11 or for detecting and identifying poultry 11 which are still unclean after cleaning/washing.

1. A processing line for processing products of the food processing industry, the processing line comprising:
a transport device, configured and adapted for the suspended transport of separated products along a transport path in a transport direction;
at least two processing stations which are arranged along the transport path, wherein the at least two processing stations are arranged one behind the other in the transport direction; and
a control device for automated control of the processing line, wherein the transport device and each processing station of the at least two processing stations are connected to the control device;
wherein a first processing station of the at least two processing stations is arranged upstream in the transport direction and is assigned a detection means which is configured and adapted for detecting a processing result from the first processing station and for transmitting information to the control device,
wherein the processing line additionally comprises means for identifying products, and the control device is configured and adapted to process the information obtained from the detection means and to mark those products defined as being unsatisfactorily processed by activating the means for identifying along the transport path.

2. The processing line according to claim 1, wherein the processing line is a slaughter line for stunned poultry, and wherein the first processing station is an apparatus for killing stunned poultry.

3. The processing line according to claim 1 wherein the at least two processing stations comprises more than two processing stations arranged one behind the other in the transport direction, the or each processing station of the at least two processing stations is assigned a detection means for detecting a processing result, the detection means being connected to the control device.

4. The processing line according to claim 1, wherein the transport device comprises a circularly driven transport chain, on which shackles are arranged for receiving, holding and transporting one suspended poultry body each.

5. The processing line according to claim 1, wherein each processing station arranged downstream in the transport direction is configured and adapted only to process those products that have been processed correctly in an adjacent upstream processing station.

6. The processing line according to claim 1, wherein the detection means comprises at least one camera for recording the processing result of the respective processing station wherein the camera is configured and adapted to transmit this information to the control device.

7. The processing line according to claim 1, wherein the or each detection means comprises at least one detection element for determining power consumption of an electric motor assigned to one or each processing station wherein the detection element is configured and adapted to transmit this information to the control device.

8. The processing line according to claim 1, wherein the or each processing station comprises a processing tool driven by an electric motor.

9. The processing line according to claim 2, wherein the apparatus for killing the stunned poultry bodies comprises a circular blade to which an electric motor is assigned in order to drive said blade in rotation.

10. The processing line according to claim 7, wherein the or each electric motor is linked via an interface to a start-up control and is connected to the control device.

11. The processing line according to claim 10, wherein the control device comprises a programmable logic controller linked to an operating element.

12. The processing line according to claim 1, wherein the means for identifying products comprises illumination means which are connected to the control device and are configured and adapted to mark the products transported along the transport path which have been unsatisfactorily processed.

13. The processing line according to claim 1, wherein as a means for identifying products, a light band is arranged along the transport path parallel to the transport device, which light band, by the control device, marks each unsatisfactorily processed poultry body with at least one light spot, wherein the or each light spot is configured and adapted such that it moves along with the unsatisfactorily processed product in the transport direction.

14. The processing line according to claim 4, wherein each shackle is assigned an illumination means as a means for identifying products, such that the illumination means is configured and adapted to be movable along with the shackle.

15. The processing line according to claim 1, wherein the means for identifying products comprises an illumination means which are configured and adapted to assign different light colours to different processing stations.

16. A method for processing products of the food processing industry, the method comprising the steps of:
transporting suspended separated products along a transport route in the transport direction by a transport device,
processing of the products at a first processing station arranged along the transport route,
processing of the products processed at the first processing station at least at a second processing station arranged after the first processing station in the transport direction,
wherein the transport device and the processing stations are controlled by a control device for an automated method,
wherein the first processing step at the first processing station is detected by a detection means with respect to the processing result, and the information is transmitted to the control device such that the or each subsequent processing step is only performed if the first processing step has been performed correctly, and in that products which have been unsatisfactorily processed are marked, by the control device, by a means for identifying products along the transport path.

17. The method according to claim 16, wherein the method is used for processing stunned poultry, wherein stunned poultry are killed in a first processing step at the first processing station and the killed poultry are further processed at at least one second processing station.

18. The method according to claim 16, wherein the or each processing step is monitored by at least one camera, and the information is transmitted to the control device.

19. The method according to claim 16, wherein the or each processing step is monitored by at least one detection element for determining the power consumption of an electric motor assigned to one or each processing station, and the information is transmitted to the control device.

20. The method according to claim 16, wherein products which have been identified by the control device, using the processing result transmitted by the detection means, as being unsatisfactorily processed, are marked by an illumination means activated by the control device such that, upon transport along the transport path from the first processing station to the processing station arranged downstream thereof, the products marked as unsatisfactory are identifiable as being unsatisfactory.

21. The method according to claim 16, wherein light spots light up underneath the products identified as being unsatisfactorily processed, such that these products are re-processed or removed before reaching the next processing station in the transport direction.

22. The method according to claim 16, wherein light spots light up on shackles from which the products are transported in a suspended manner along the transport route when these products have been identified as being unsatisfactorily processed, such that these products are re-processed or removed before reaching the next processing station in the transport direction.

23. The method according to claim 16, wherein a plurality of processing stations arranged one behind the other in the transport direction are detected with respect to their processing result, wherein each of the products identified as being unsatisfactorily processed is assigned at least one coloured light spot which can be assigned to a specific processing station in relation to the colour.

24. The method according to claim 16, wherein an alarm is triggered in the event that a predetermined number of unsatisfactorily processed products is generated at one processing station of the processing line.

25. A method for processing products of the food processing industry, the method comprising the steps of:
transporting suspended separated products along a transport route in the transport direction by of a transport device,
processing of the products at a first processing station arranged along the transport route,
processing of the products processed at the first processing station at least at a second processing station arranged after the first processing station in the transport direction,
wherein the transport device and the processing stations are controlled by a control device for an automated method.
wherein the first processing step at the first processing station is detected by a detection means with respect to the processing result, and the information is transmitted to the control device such that the or each subsequent processing step is only performed when the first processing step has been performed correctly, and in that products which have been unsatisfactorily processed are marked, by the control device, by a means for identifying products along the transport path.
said method is performed with the processing line according to claim 1.
